(19) United States
(12) Patent Application Publication
(10) Pub. No.: US 2026/0138531 A1
(43) Pub. Date: May 21, 2026

(54) VISION SYSTEM FOR CORRECTING POSITION OF GOLF VEHICLE

(71) Applicant: Textron Inc., Providence, RI (US)

(72) Inventors: Shayne Evan Rimer, North Augusta, SC (US); Brad Hof, Providence, RI (US); Lance Fielder, Providence, RI (US)

(73) Assignee: Textron Inc., Providence, RI (US)

(21) Appl. No.: 18/953,918

(22) Filed: Nov. 20, 2024

(51) Int. Cl. B60R 1/27

(52) U.S. Cl. CPC B60R 1/27; B60Y 2200/86; B60Y 2400/3015

(57) ABSTRACT

A golf vehicle system includes a vision system including at least one sensor configured to facilitate acquiring vision data of an environment surrounding a golf vehicle and one or more processing circuits configured to determine, based on the vision data, a detected location of the golf vehicle relative to a marker included in the vision data. The marker is associated with a known location at a golf course. The one or more processing circuits are configured to determine a corrective position of the golf vehicle based on the detected location and the known location.

### BACKGROUND

Golf carts are commonly used by golfers while playing a round of golf to drive between holes, to their ball, and to carry their bags. Other vehicles, such as drink carts, ground maintenance vehicles, recreational vehicles, utility vehicles, etc. are also commonly found at a golf course. Keep-out geofences may be established around areas of the golf course where the golf carts and other vehicles should not drive. These areas may include greens, tee boxes, buildings, water, woods, among others. When the golf cart or the other vehicles drive in the area defined by the keep-out geofence, the operation thereof may be limited.

### SUMMARY

One embodiment relates to a golf vehicle system. The golf vehicle system includes a vision system including at least one sensor configured to facilitate acquiring vision data of an environment surrounding a golf vehicle and one or more processing circuits configured to determine, based on the vision data, a detected location of the golf vehicle relative to a marker included in the vision data. The marker is associated with a known location at a golf course.

The one or more processing circuits are configured to determine a corrective position of the golf vehicle based on the detected location and the known location.

Another embodiment relates to a vehicle system. The vehicle system includes one or more processing circuits including one or more memory devices coupled to one or more processors. The one or more memory devices are configured to store instructions thereon that, when executed by the one or more processors, cause the one or more processors to acquire vision data including a marker in an environment surrounding a vehicle, the marker associated with a known location, determine a detected location of the vehicle relative to the marker based on the vision data, the detected location including a distance and an orientation of the vehicle relative to the marker, determine a corrective position of the vehicle based on the detected location and the known location, and control an operation of the vehicle based on the corrective position.

Still another embodiment relates to a golf vehicle system. The golf vehicle system includes a non-transitory computer-readable medium having instructions stored thereon that, when executed by one or more processors, cause the one or more processors to acquire vision data including a first marker in an environment surrounding a golf vehicle, the first marker associated with a first known location, determine a detected location of the golf vehicle relative to the first marker based on the vision data, the detected location including a distance and an orientation of the golf vehicle relative to the first marker, acquire vision data of a ground surface including a second marker associated with a second known location, the second marker positioned along the ground surface such that as the golf vehicle drives over or proximate the second marker, the vision data including the second marker is acquired, determine at least one of (i) a corrective position of the golf vehicle based the detected location and the first known location or (ii) responsive to driving over or proximate the second marker, that the corrective position of the golf vehicle is the second known location of the second marker, and control an operation of the golf vehicle based on the corrective position of the golf vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a top view of a golf course including the vehicle of FIG. 1, according to an exemplary embodiment.

FIG. 6 is a top view of a golf course including the vehicle of FIG. 1, according to an exemplary embodiment.

FIG. 7 is a perspective view of a portion of the golf course of FIGS. 5 and 6 including machine-readable markers, according to an exemplary embodiment.

FIG. 8 is a perspective view of a portion of the golf course of FIGS. 5 and 6 including machine-readable markers coupled to a bridge, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

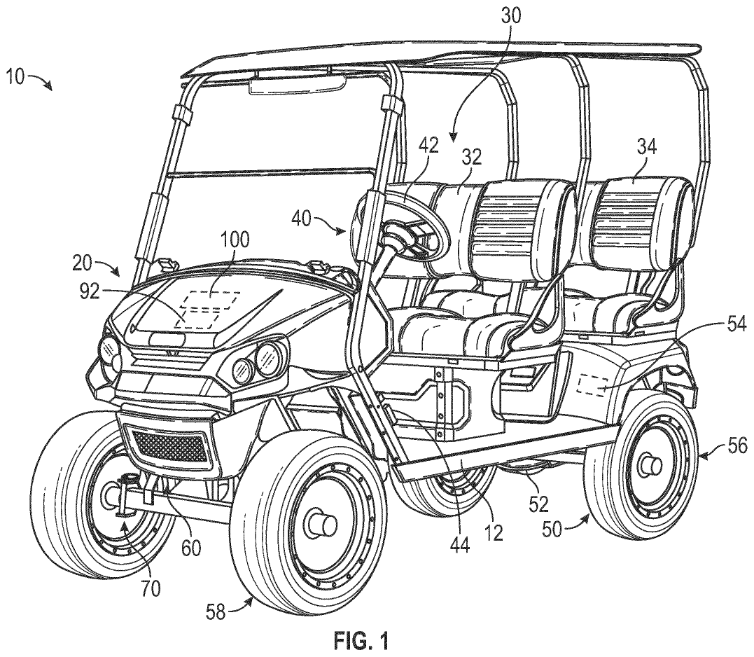

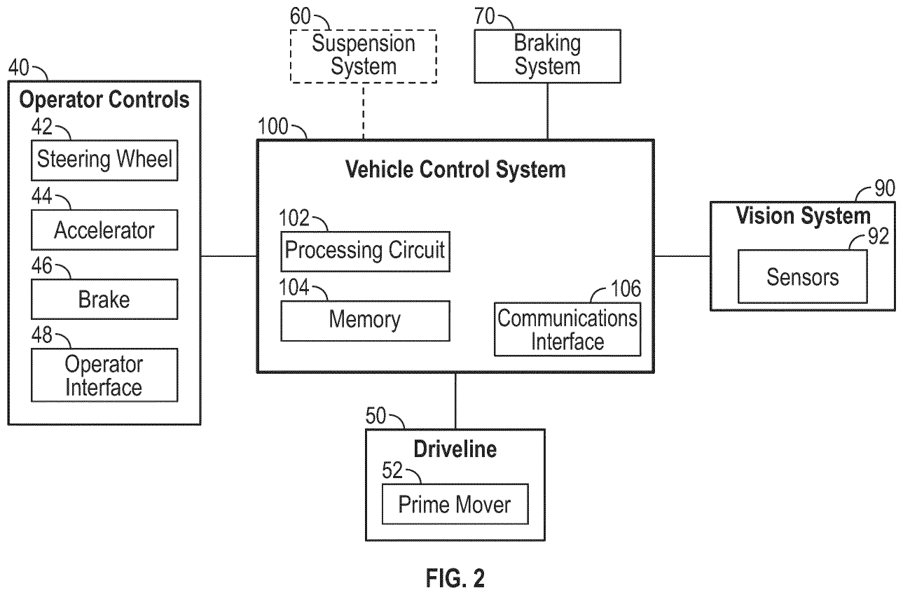

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; a sensor system, shown as vision system 90; and a control system, shown as vehicle control system 100, coupled to the operator controls 40, the driveline 50, the suspension system 60, the braking system 70, and the vision system 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

As shown in FIGS. 1 and 2, the vision system 90 includes one or more first sensors, shown as sensors 92, variously positioned about the vehicle 10 at fixed, known, and stationary locations relative to the vehicle 10. The sensors 92 may be positioned along a front, rear, side, top and/or bottom side of the vehicle 10. The sensors 92 may be coupled to one or more components of the vehicle 10. The sensors 92 may acquire vehicle information or vehicle data regarding operation of the vehicle 10 and/or the location thereof. By way of example, the sensors 92 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, a Lidar sensor, an optical sensor, a proximity detection sensor, a Doppler/radar sensor, and/or other sensors to facilitate acquiring vehicle information or vehicle data regarding operation of the vehicle 10 and/or the location thereof. According to an exemplary embodiment, one or more of the sensors 92 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data. According to another exemplary embodiment, one or more of the sensors 92 are configured to facilitate detecting and obtaining environment data including locations of objects (e.g., hazards, markers, etc.), terrain type (e.g., grass, pavement, gravel, sand, etc.), and/or other environment data of the area surrounding the vehicle 10.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein.

According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 92. By way of example, the vehicle control system 100 may send and receive signals (e.g., control signals, location signals, etc.) with the components of the operator controls 40, the components of the driveline 50, the components of the braking system 70, the sensors 92, and/or remote systems or devices (via the communications interface 106 as described in greater detail herein).

### Electrified Driveline

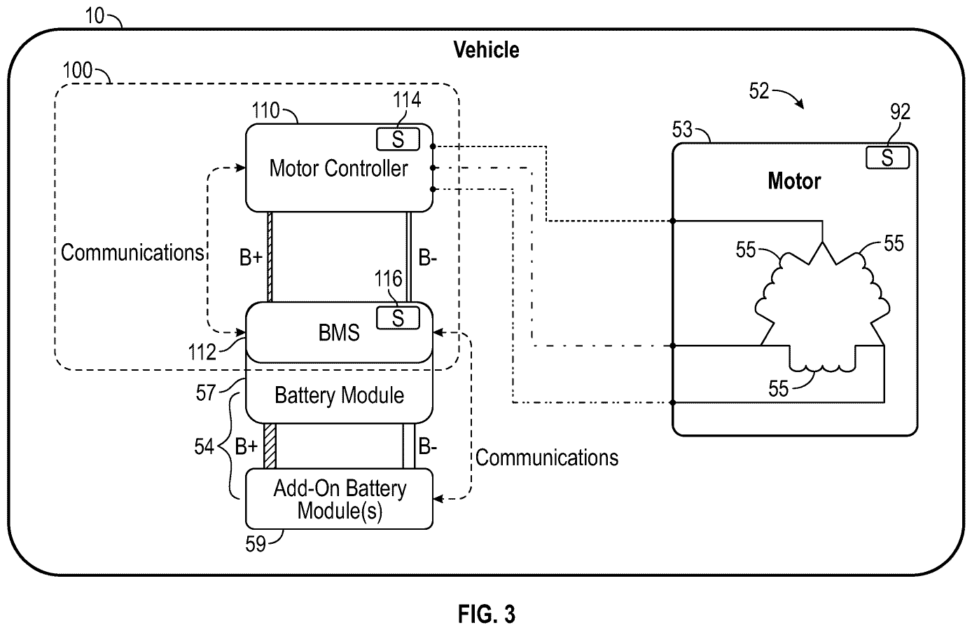

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

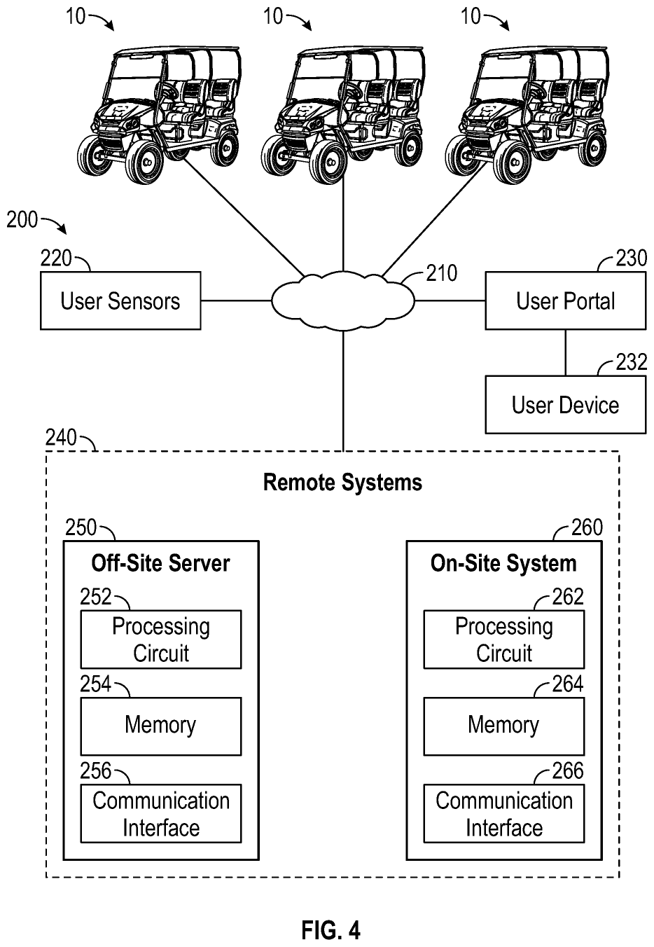

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Vision Based Location Detection and Adjustment

According to an exemplary embodiment, the fleet monitoring and control system 200, including the vehicle controller 100, the user sensors 220, the user portal 230, and the remote systems 240, is configured to facilitate improving or enhancing location detection of the vehicles 10 and associated control thereof based on location. Further, it should be understood that any of the functions or processes described herein with respect to the fleet monitoring and control system 200 may be performed by the vehicle controller 100 and/or the remote systems 240. By way of example, data collection may be performed by the vehicle controller 100 and data analytics may be performed by the vehicle controller 100. By way of another example, data collection may be performed by the vehicle controller 100 and data analytics may be performed by the remote systems 240. By way of yet another example, data collection may be performed by the vehicle controller 100, a first portion of data analytics may be performed by the vehicle controller 100, and a second portion of data analytics may be performed by the remote systems 240. By way of still another example, a first portion of data collection may be performed by the vehicle controller 100, a second portion of data collection may be performed by the remote systems 240, and data analytics may be performed by the vehicle controller 100 and/or the remote systems 240.

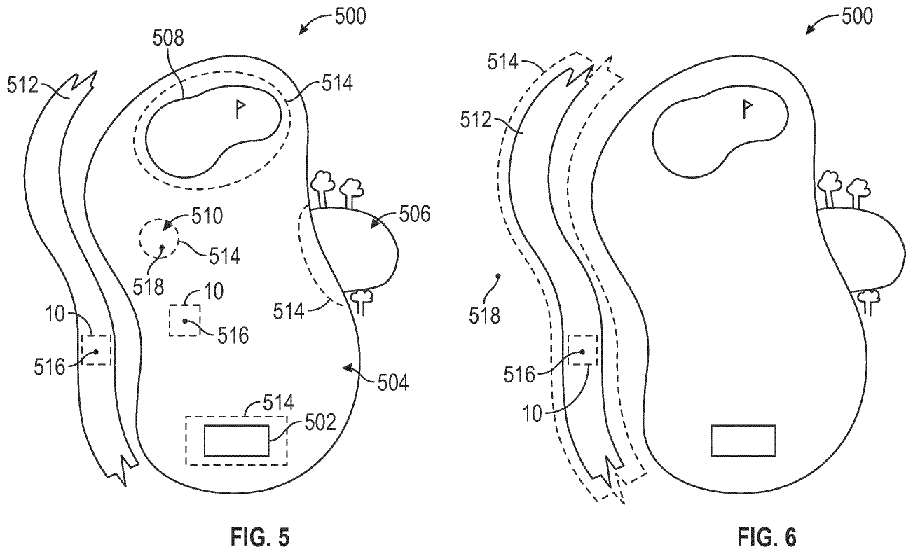

As shown in FIG. 5, the vehicle 10 may be a golf cart driven by an operator playing golf on a golf course 500. In some embodiments, the vehicle 10 is a drink cart, a cart driven by an employee of the golf course 500 monitoring the pace of play of golfers, a cart driven by the maintenance crew working at the golf course 500, or another type of vehicle or vehicle commonly found at golf courses (e.g., a turf mower, a sprayer, an aerator, a bunker rake, etc.). A hole of the golf course 500 is shown including a tee box 502; a fairway 504; a water hazard, woods, fescue, etc., shown as out-of-bounds area 506; a putting green, shown as green 508; an area in the fairway 504 that is under repair, a non-playable area, etc., shown as hazard 510; and a path, a trail, a cart route, etc., shown as cart path 512.

The golf course 500 includes areas that should not be driven on, in, or around by the vehicle 10. By way of example, these areas may include the tee box 502, the out-of-bounds area 506, the fairway 504 during certain conditions (e.g., rain, flooding, under repair, etc.), the green 508, the hazard 510, private property along the golf course 500, a club house of the golf course 500, roped-off areas, dry/brown grass areas, areas with new sod, and/or another areas of the golf course 500. Driving on, in, or around these areas by the vehicle 10 may damage the golf course 500, be dangerous for an operator of the vehicle 10, damage the vehicle 10, be illegal (e.g., trespassing on private property), etc. Collectively, these areas are hereinafter referred to as restricted areas. Accordingly, one or more geofences (e.g., a virtual boundary, a virtual fence, etc.), shown as geofences 514, may be established around the restricted areas. The geofences 514 may be areas or boundaries defined around the restricted areas to control and manage the operation of the vehicle 10 on the golf course 500. By way of example, when the vehicle 10 is driven beyond the virtual boundary of the geofence 514 (i.e., driven into a restricted area), the operation of the prime mover 52 of the vehicle 10 may be limited (e.g., limit speeds below a speed threshold such as below 5 miles per hour, prevent forward travel of the vehicle 10, limit the vehicle 10 to backward travel only, disabled, limited or restricted operation, etc.). Areas of the golf course 500, such as the cart path 512, a parking lot of the golf course 500, the fairway 504, a cart return area, etc. that are not restricted areas defined by a geofence 514 may be drivable (e.g., navigable, permitted, unrestricted operation, etc.) by the vehicle 10, and are hereinafter referred to as the drivable areas. In some embodiments, a cart path only rule may be implemented where the vehicle 10 is supposed to drive on the cart path 512 only (e.g., after or during heavy rainfall). In such an embodiment, the geofence 514 may be established everywhere except for the cart path 512.

As shown in FIG. 6, the geofence 514 is established around the cart path 512. The geofence 514 formed around the cart path 512 may facilitate implementing the cart path only rule where the vehicle 10 is supposed to drive on the cart path 512 only (e.g., after or during heavy rainfall, to avoid ground under repair, when the cart path 512 is a bridge crossing a river/pond, etc.). As shown in FIG. 6, rather than defining geofences 514 around the restricted areas (i.e., everywhere but the cart path 512), a geofence 514 (e.g., a cart path geofence) is formed around the cart path 512. By way of example, when the vehicle 10 is driven beyond the virtual boundary of the geofence 514 (i.e., driven off of the cart path 512 and into a restricted area), the operation of the prime mover 52 of the vehicle 10 may be limited (e.g., limit speeds below a speed threshold such as below 5 miles per hour, prevent forward travel of the vehicle 10, limit the vehicle 10 to backward travel only, disabled, limited or restricted operation, etc.).

According to an exemplary embodiment, a location of the vehicle 10 is monitored by the fleet monitoring and control system 200 to determine the location of the vehicle 10 relative to the geofence 514, the restricted areas, and the drivable areas. The location of the vehicle 10 may be determined based on GPS data (e.g., collected by the sensors 92 and/or the user sensors 220). The fleet monitoring and control system 200 may be configured to store the location data and analyze the location data to make operational decisions based thereon. As shown in FIG. 5, a location (e.g., real-time position, corrective position, true location, etc.), shown as true location 516, of the vehicle 10 may be different than a tracked position of the vehicle 10 determined based on GPS data (e.g., collected by the sensors 92 and/or the user sensors 220), shown as tracked location 518. The true location 516 may be different from the tracked location 518 as a result of GPS drift, as discussed in greater detail below.

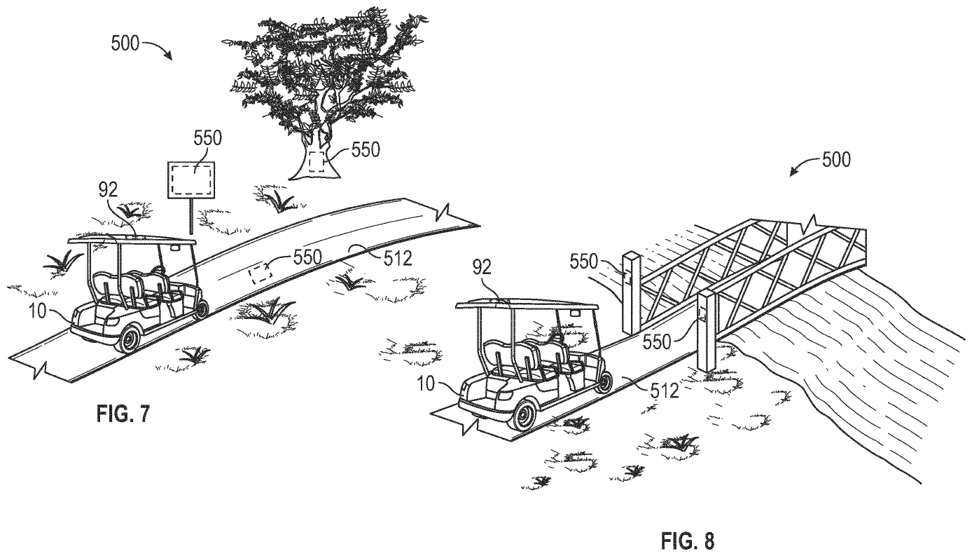

As shown in FIGS. 7 and 8, one or more identifiers (e.g., labels, landmarks, anchor points, features, etc.), shown as markers 550, are positioned throughout the golf course 500. In some embodiments, the markers 550 include a quick response (“QR”) code, a barcode, a color marker, a shape or pattern marker, or some other a machine-readable marker or descriptor configured to be identifiable (e.g., perceptible, visible, recognizable, readable, detectable, etc.) by the sensors 92 of the vision system 90. In some embodiments, the markers 550 additionally or alternatively include tracking tags such at radio frequency identification (“RFID”) tags, near field communication (“NFC”) tags, Bluetooth Low-Energy (“BLE”) enabled tags, etc., configured to facilitate communication with or between (e.g., transmit one or more signals with or between) the sensors 92 of the vehicle 10. The markers 550 may be positioned throughout the golf course 500 such that the markers 550 are identifiable by the sensors 92 of the vision system 90 as the vehicle 10 navigates throughout the golf course 500 (e.g., during a round being played by a golfer, during ground maintenance and repair such as mowing, raking, aerating, etc.). By way of example, the markers 550 may be coupled to, painted on, printed on, etc. a ground surface such as the cart path 512, the fairway 504, etc., coupled to, painted on, printed on, etc. a sign (e.g., a sign identifying the hole, a sign identifying yardage, etc.), coupled to, painted on, printed on, etc. a post or railing of a bridge on the golf course 500, coupled to a tree, and/or otherwise positioned along a route that the vehicle 10 is configured to drive along (e.g., along the cart path 512, in a parking lot, in the fairway 504, over a bridge, etc.).

The markers 550 are positioned at a fixed, precise, and stationary location during installation thereof at the golf course 500. This fixed, precise, and stationary location is a reference location (e.g., a known location/position, a true location/position, etc.) used during a correction process to correct the position of the vehicles 10 relative to other features of the golf course 500 (e.g., the geofences 514, restricted areas, drivable areas, pin locations, buildings, etc.). The reference location may be acquired (e.g., determined) using GPS techniques including a GPS device (e.g., a user sensor 220, a hand-held TruPin GPS device offered by E-Z-GO® used by a groundskeeper of the golf course 500, etc.), using real-time kinematic (“RTK”) techniques including a base station in communication with a global navigation satellite system (“GNSS”), or other methods to acquire the fixed, precise, and stationary location of the markers 550. The reference location may be stored by the memory of the controller 100, the memory 254 of the off-site server 250, the memory 264 of the on-site system 260, and/or the user device 232. In some embodiments, data associated with the reference location of the markers 550 is transmitted between the vehicles 10, the off-site server 250, and/or the on-site system 260. In some embodiments, the markers 550 (e.g., the RFID tags, the NFC tags, BLE enabled tags, etc.) include a memory configured to store the reference locations thereof and transmit data associated therewith to the vehicles 10, the off-site server 250, and/or the on-site system 260.

According to an exemplary embodiment, the vision system 90 is configured to acquire vision data of an environment surrounding the vehicle 10 using the sensors 92 as the vehicle 10 navigates throughout the golf course 500 to (i) detect the markers 550 and determine a location of the vehicle 10 relative to the markers 550 and/or (ii) detect drivable areas, such as the cart path 512, and determine a location of the vehicle 10 relative to the drivable areas. The sensors 92 may transmit the vision data to the vehicle controller 100 and/or the remote systems 240 to be analyzed thereby to detect the markers 550 and/or the drivable areas. In some embodiments, the sensors 92 include cameras configured to capture image and/or video data of the environment surrounding the vehicle 10 and transmits the image and/or video data to the vehicle controller 100 and/or the remote systems 240 to determine the presence or absence of the markers 550 and/or the drivable areas. By way of example, the vehicle controller 100 and/or the remote systems 240 may detect a presence of one or more markers 550 based on the vision data (e.g., responsive to scanning a QR code, barcode, etc. ; detecting a color, shape, pattern, etc. associated with the markers 550, etc.). By way of another example, the vehicle controller 100 and/or the remote systems 240 may detect a boundary of the cart path 512 based on the vision data. In some embodiments, the sensors 92 are configured to establish communications with the markers 550 (e.g., the markers 550 configured as RFID tags, NFC tags, BLE enabled tags, etc.) when the vehicle 10 is driven within a communication range of the markers 550, and, responsive to the communications being established between the markers 550 and the sensors 92, the vehicle controller 100 and/or the remote systems 240 determine the presence of the markers 550. In some embodiments, the sensors 92 include Lidar sensors, distance sensors, etc., configured to acquire data indicative of a distance between the sensors 92 (e.g., the vehicle 10) and the markers 550. Based on the vision data, the vehicle controller 100 and/or the remote systems 240 are configured to determine a detected location of the vehicle 10 relative to the markers 550 (e.g., the detected markers 550) and/or the drivable areas. The detected location of the vehicle 10 relative to the markers 550 and/or the drivable areas may include a position (e.g., a distance) and an orientation (e.g., a heading, an angle, a pose, etc.) of the vehicle 10 relative to the markers 550 and/or the drivable areas.

In some embodiments, the vision system 90 continuously or substantially continuously (e.g., once every second or at a quicker frequency) transmits signals associated with the vision data captured by the sensors 92 to the vehicle controller 100 and/or the remote systems 240. In such embodiments, the vehicle controller 100 and/or the remote systems 240 continuously or substantially continuously analyze the vision data to determine the presence or absence of the markers 550 and determine, responsive to a determination of the presence of the markers 550, the detected location of the vehicle 10 relative to the markers 550. In other embodiments, the vision system 90 periodically transmits signals associated with the vision data to the vehicle controller 100 and/or the remote systems 240 (e.g., every ten seconds, every thirty seconds, every minute, when a marker 550 is detected thereby, etc.).

The vision data (e.g., the detected location of the vehicle 10 relative to the markers 550) and the reference location of the markers 550 may be used to correct position data of the vehicles 10. The vehicle controller 100 and/or the remote systems 240 may be configured to compare (i) the detected location of the vehicle 10 relative to the markers 550 with (ii) the reference location of the markers 550. Based on the comparison between the detected location and the reference location, the vehicle controller 100 and/or the remote systems 240 are configured to determine corrective position data (e.g., error data). The corrective position data may be indicative of an error or difference between the tracked location 518 and the true location 516 of the vehicle 10 (e.g., errors/differences caused by GPS drift as discussed in greater detail below). In other words, based on the comparison between the detected location of the vehicle 10 relative to the markers 550 and the reference location of the markers 550, the vehicle controller 100 and/or the remote systems 240 are configured to determine the true location 516 of the vehicle 10 (e.g., a location of the vehicle 10 that is not affected by GPS drift). By way of example, the sensors 92 may acquire vision data including a respective marker 550 coupled to a sign or a tree, for example, and the vehicle controller 100 and/or the remote systems 240 may determine corrective position data (e.g., determine the true location 516 of the vehicle 10) based on comparing the vision data (e.g., the detected location of the vehicle 10 relative to the respective marker 550 determined based on the vision data) with the reference location of the respective marker 550. In some embodiments, the vehicle controller 100 and/or the remote systems 240 determine corrective position data without comparing the vision data with the reference location of a respective marker 550. By way of example, the vehicle 10 may drive over the respective marker 550 positioned on the cart path 512 and the sensors 92 (e.g., ground-facing sensors) are configured to acquire vision data including the respective marker 550. In such an example, based on the vision data of the respective marker 550 and the reference location of the respective marker 550, the vehicle controller 100 and/or the remote systems 240 may determine corrective position data (e.g., set the tracked location 518 to be the reference location of the respective marker 550). In other words, because the vehicle 10 drives over the respective marker 550 associated with a respective reference location, the vehicle controller 100 and/or the remote systems 240 may update the tracked location 518 to be the respective reference location of the respective marker 550 without comparing a detected location of the vehicle 10 relative to the respective marker 550 determined based on the vision data with the respective reference location of the respective marker 550.

In some embodiments, the vision data acquired by the sensors 92 includes the presence of two or more markers 550. In such embodiments, the vehicle controller 100 and/or the remote systems 240 determines corrective position data (e.g., determines the true location 516 of the vehicle 10) by performing a geometric calculation based on (e.g., triangulating) the respective reference locations of the two or more markers 550 with the detected location of the vehicle 10 relative to each of the two or more markers 550. By way of example, a first marker 550 may be coupled with a bridge of the golf course 500 along a first side thereof and a second marker 550 may be coupled with the bridge along a second side thereof (see, e.g., FIG. 8). In such an example, the sensors 92 may acquire vision data including the first marker 550 and the second marker 550 and the vehicle controller 100 and/or the remote systems 240 may determine corrective position data (e.g., determine the true location 516 of the vehicle 10) by triangulating the respective reference locations of the first marker 550 and the second marker 550 with the detected location of the vehicle 10 relative to the first marker 550 and the second marker 550.

An error or difference between the tracked location 518 and the true location 516 of the vehicle 10 (e.g., an error or difference between a GPS location of the vehicle 10 and a real-time position of the vehicle 10) may be caused by signal interference (e.g., geomagnetic radiation), solar storms, signal obstruction (e.g., tree cover, building cover, etc.), weather (e.g., rain, snow, pressure, etc.), control system quality, malfunctioning sensors, incremental errors between the tracked location 518 and the true location 516 compounding over time, and/or any other combination of internal hardware or external factors. The difference between the tracked location 518 and the true location 516 may be referred to herein as location or GPS drift.

Because of the difference between the tracked location 518 and the true location 516, the fleet monitoring and control system 200 may determine, based on the tracked location 518, that the vehicle 10 is operating in a restricted area (e.g., near/on a green or tee box, near/on a hazard such as ground under repair, an area defined by a geofence 514, a non-drivable area, etc.) when in reality, the true location 516 of the vehicle 10 is not in the restricted area. In such an example, the fleet monitoring and control system 200 may undesirably limit the operation of the vehicle 10. Similarly, because of the difference between the tracked location 518 and the true location 516, the fleet monitoring and control system 200 may determine, based on the tracked location 518, that the vehicle 10 is not operating in the restricted area (e.g., operating in the drivable area) when in reality, the true location 516 of the vehicle 10 is in the restricted area. In such an example, the fleet monitoring and control system 200 may undesirably permit operation of the vehicle 10 within the restricted area.

When the vehicle 10 is operating close to or in drivable areas that are relatively narrow such as operating close to or on a bridge (e.g., shown in FIG. 8), other vehicle control systems may force the tracked location 518 of the vehicle 10 to be within the narrow drivable area in an attempt to correct for undesirable controlling of the operation of the vehicle 10. By way of example, when a vehicle 10 is operating close to a bridge built over a restricted area (e.g., an out-of-bounds area, a hazard, a river, a pond, a creek, wet areas, fescue, etc.), the other vehicle control system may force the tracked location 518 of the vehicle 10 to be on the bridge (e.g., update the tracked location 518 to be on the bridge) when the tracked location 518 indicates the vehicle 10 is operating in the restricted area, when in reality, the vehicle 10 is operating in a drivable area. In such an example, the other vehicle control system forces the tracked location 518 of the vehicle 10 to be on the bridge even though the true location 516 of the vehicle 10 is not on the bridge and is instead in a safe and drivable area close to the bridge, thereby creating an error or difference between the tracked location 518 and the true location 516.

To correct (e.g., adjust for, account for, etc.) the undesirable controlling of the operation of the vehicles 10 as a result of the GPS drift and/or incorrect tracked location 518 updates, the vehicle controller 100 and/or the remote systems 240 are configured to determine a corrective position of the vehicle 10 based on the detected location thereof relative to the markers 550 and the corrective position data (e.g., associated with a difference between the tracked location 518 and the true location 516) and make operational decisions based on the corrective position. In some embodiments, the vehicle controller 100 and/or the remote systems 240 are configured to determine the corrective position of the vehicle 10 based on the tracked location 518 thereof (e.g., based on vehicle GPS data) and the corrective position data. In some embodiments, the vehicle controller 100 and/or the remote systems 240 are configured to use the corrective position data to update (e.g., change, modify, augment, etc.) the tracked location 518 and control operation of the vehicle 10 based on the tracked location 518 (e.g., the updated tracked location 518). In other embodiments, in response to a determination of a difference between the tracked location 518 and the true location 516, the vehicle controller 100 and/or the remote systems 240 are configured to control operation of the vehicle 10 based on the corrective position (e.g., disregard the tracked location 518 and control operation of the vehicle 10 based on the true location 516). Controlling operation of the vehicles 10 based on the corrective position ensures that the difference between the real-time positions and the GPS positions caused by GPS drift does not adversely affect operation of the vehicles 10 (e.g., limiting driving operations of the vehicles 10 when the vehicles 10 are in the drivable areas, permitting driving operations of the vehicles 10 when the vehicles 10 are in the restricted areas, etc.).

According to an exemplary embodiment, the vehicle controller 100 of the vehicle 10 is configured to determine the corrective position of the vehicle 10 based on the GPS data of the vehicle 10 (e.g., the tracked location 518) and the corrective position data (e.g., determined by the vehicle controller 100 and/or the remote systems 240), and transmit the corrective position to the remote systems 240 such that operation of the vehicle 10 is controlled by the remote systems 240 based on the corrective position (and not based on the potentially wrong GPS position for the vehicle 10 as a result of GPS drift). In other embodiments (e.g., where the vehicle controller 100 does not determine the corrective position), the vehicle controller 100 is configured to transmit the GPS data regarding the GPS position of the vehicle 10 and/or the corrective position data to the remote systems 240 such that the remote systems 240 can determine the corrective position of the vehicle 10 and control operation of the vehicle 10 based on the corrective position (and not based on the potentially wrong GPS data for the vehicle 10 as a result of GPS drift). By way of example, the corrective position accounts for the errors between the real-time positions and the GPS positions caused by GPS drift because the corrective position is determined based on the corrective position data. Therefore, the corrective position determined by the vehicle controller 100 and/or the remote systems 240 is indicative of the real-time position of the vehicle 10.

In some embodiments, the remote systems 240 and the vehicles 10 are continuously or substantially continuously in communication such that the vehicle controller 100 and/or the remote systems 240 can continuously or substantially continuously determine the corrective position of each vehicle 10, thereby continuously or substantially continuously providing corrective position data indicative of the corrective position and/or the corrective position of the vehicles 10 to the vehicle controller 100 and/or the remote systems 240.

According to an exemplary embodiment, the vehicle controller 100 and/or the remote systems 240 are configured to change or correct the tracked location 518 (e.g., compensate for GPS drift). By way of example, the vehicle controller 100 and/or the remote systems 240 may be configured to force the tracked location 518 to be within the drivable area in response to a determination, based on the corrective position (e.g., the true location 516), that the vehicle 10 is traveling in the drivable area and the tracked location 518 indicates that the vehicle 10 is in the restricted area. By way of another example, the vehicle controller 100 and/or the remote systems 240 may be configured to force the tracked location 518 to be within the restricted area in response to a determination, based on the corrective position, that the vehicle 10 is traveling in the restricted area and the tracked location 518 indicates that the vehicle 10 is in the drivable area. In some embodiments, when a determination is made that the true location 516 is different than the tracked location 518 (e.g., the coordinates are different), the vehicle controller 100 and/or the remote systems 240 may be configured to recalibrate (e.g., reset) the sensors 92 collecting the GPS data and/or send a signal commanding the user sensors 220 to recalibrate.

The vehicle controller 100 and/or the remote systems 240 may control an operation of the operator controls 40, the driveline 50, the suspension system 60, the braking system 70, and/or any other component of the vehicle 10 based on the corrective position of the vehicle 10 relative to the geofences 514. By way of example, the vehicle controller 100 and/or the remote systems 240 may determine, based on the corrective position, that the vehicle 10 is operating (e.g., driving forward, driving backward, idling, stopped, parked, etc.) (i) in a drivable area, (ii) near a geofence 514 (e.g., within 5 yards of the geofence 514, within 10 yards of the geofence 514, etc.), or (iii) in a restricted area defined by the geofence 514. In response to a determination that the vehicle 10 is operating in a drivable area, the vehicle controller 100 and/or the remote systems 240 may facilitate (e.g., permit operation of the vehicle 10 in a first mode of operation) normal or unrestricted operation of the operator controls 40, the driveline 50, the suspension system 60, the braking system 70, and/or any other component of the vehicle 10. In response to a determination that the vehicle 10 is operating near or in the geofence 514, the vehicle controller 100 and/or the remote systems 240 may limit operation (e.g., limit operation of the vehicle 10 in a second mode of operation) of the operator controls 40, the driveline 50, the suspension system 60, the braking system 70, and/or any other component of the vehicle 10. By way of example, the vehicle controller 100 and/or the remote systems 240 may limit operation of the prime mover 52 such that the vehicle 10 (i) cannot exceed a threshold speed (e.g., 5 miles per hour, 2 miles per hour, etc.), (ii) is limited to rearward travel, and/or (iii) any other control to limit operation of the vehicle 10. In some embodiments, in response to a determination by the vehicle controller 100 and/or the remote systems 240 that the vehicle 10 is operating near the geofence 514, the operator interface 48 may display a warning providing an indication to the operator of the vehicle 10 of the geofence 514 (e.g., warning the operator of the location of the geofence 514, warning the operator that the vehicle 10 is approaching the geofence 514, etc.). In some embodiments, in response to a determination by the vehicle controller 100 and/or the remote systems 240 that the vehicle 10 is operating in the geofence 514, the operator interface 48 may display a warning providing instructions to the operator to navigate the vehicle 10 out of the geofence 514. In some embodiments, in response to a determination by the vehicle controller 100 and/or the remote systems 240 that the vehicle 10 is operating in the geofence 514, the operator interface 48 and/or the user portal 230 may display a warning, a distance indicating how far the vehicle 10 has traveled in the geofence 514, and/or a time indicating how long the vehicle 10 has been operating in the geofence 514. The parameters for triggering such warning may be set using the user portal 230. In some embodiments, in response to a determination by the vehicle controller 100 and/or the remote systems 240 that the vehicle 10 is operating in the geofence 514, the vehicle controller 100 and/or the remote systems 240 disable/limit the vehicle 10, provide the warning on the operator interface 48, and/or provide the warning on the user portal 230. In some embodiments, the vehicle controller 100 and/or the remote systems 240 facilitate autonomous or semi-autonomous navigation of the vehicle 10 throughout the golf course 500 based on the vision data acquired by the sensors 92 and the corrective position data. By way of example, the vehicle controller 100 and/or the remote systems 240 may use (i) the vision data acquired by the sensors 92 to detect a location of a cart path 512 (e.g., a boundary of the cart path 512, a curvature of the cart path 512, etc.), a hazard 510, a drivable area, a restricted area, etc., and (ii) the vision data and the corrective position data to navigate along the cart path 512 between golf holes, avoid the hazard 510 and the restricted area, navigate within the drivable area, etc.

According to an exemplary embodiment, the vehicle controller 100 and/or the remote systems 240 may permit operation of the vehicle 10 when the tracked location 518 indicates that that vehicle 10 is located in the restricted area, but the true location 516 indicates that the vehicle 10 is traveling in the drivable area. By way of example, the vehicle 10 may operate normally when the vehicle 10 is actually driving on the cart path 512, even though the tracked location 518 indicates that the vehicle 10 is located in a restricted area, such as the tee box 502, the fairway 504, the out-of-bounds area 506, the green 508, or the hazard 510. When the tracked location 518 indicates that that vehicle 10 is located in the drivable area, and the true location 516 indicates that the vehicle 10 is traveling in the drivable area, the vehicle controller 100 and/or the remote systems 240 may permit operation of the vehicle 10 in the first mode of operation. When the tracked location 518 indicates that that vehicle 10 is located in the drivable area, but the true location 516 indicates that the vehicle 10 is traveling in the restricted area, the vehicle controller 100 and/or the remote systems 240 may limit operation of the vehicle 10 in the second mode of operation. By way of example, the vehicle 10 may have limited operational capabilities when the vehicle 10 is located in a restricted area, such as the tee box 502, the fairway 504, the out-of-bounds area 506, the green 508, or the hazard 510, even though the tracked location 518 indicates that the vehicle 10 is in the drivable area (e.g., the cart path 512). When the tracked location 518 indicates that that vehicle 10 is located in the restricted area, and the true location 516 indicates that the vehicle 10 is traveling in the restricted area, the vehicle controller 100 and/or the remote systems 240 may limit operation of the vehicle 10 in the second mode of operation.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 92, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf vehicle system comprising:
a vision system including at least one sensor configured to facilitate acquiring vision data of an environment surrounding a golf vehicle; and
one or more processing circuits configured to:
acquire a tracked location of the golf vehicle;
determine, based on the vision data, a detected location of the golf vehicle relative to a marker included in the vision data, the marker associated with a known location at a golf course; and
determine a corrective position of the golf vehicle relative to the tracked location based on the tracked location, the detected location, and the known location.

2. The golf vehicle system of claim 1, wherein the one or more processing circuits are configured to control an operation of the golf vehicle based on the corrective position of the golf vehicle.

3. The golf vehicle system of claim 2, wherein the at least one sensor is configured to facilitate acquiring a GPS position of the golf vehicle, wherein the tracked location is the GPS position.

4. The golf vehicle system of claim 3, wherein the one or more processing circuits are configured to permit unrestricted operation of the golf vehicle when the GPS position indicates that the golf vehicle is located in a restricted operation area, but the corrective position indicates that the golf vehicle is not in the restricted operation area.

5. The golf vehicle system of claim 4, wherein the one or more processing circuits are configured to limit operation of the golf vehicle when the GPS position indicates that the golf vehicle is not located in the restricted operation area, but the corrective position indicates that the golf vehicle is in the restricted operation area.

6. The golf vehicle system of claim 5, wherein the one or more processing circuits are configured to limit operation of the golf vehicle when the GPS position indicates that the golf vehicle is located in the restricted operation area and the corrective position indicates that the golf vehicle is in the restricted operation area.

7. The golf vehicle system of claim 6, wherein the one or more processing circuits are configured to permit operation of the golf vehicle when the GPS position indicates that the golf vehicle is not located in the restricted operation area and the corrective position indicates that the golf vehicle is not in the restricted operation area.

8. The golf vehicle system of claim 4, wherein the restricted operation area is defined by a predetermined geofence.

9. The golf vehicle system of claim 1, wherein the marker includes at least one of a quick reference code, a barcode, a color marker, a shape marker, or a pattern marker.

10. The golf vehicle system of claim 1, wherein the at least one sensor is configured to be positioned on the golf vehicle such that the at least one sensor monitors a ground surface of the golf course, wherein the marker is positioned along the ground surface of the golf course such that as the golf vehicle drives over or proximate the marker, the at least one sensor facilitates acquiring the vision data including the marker, and wherein the one or more processing circuits are configured to, responsive to driving over or proximate the marker, determine that the corrective position of the golf vehicle is the known location of the marker.

11. The golf vehicle system of claim 1, wherein the one or more processing circuits are configured to determine, based on the vision data, the detected location of the golf vehicle relative to two or more markers included in the vision data, each marker of the two or more markers associated with known locations at the golf course, and wherein determining the corrective position of the golf vehicle includes performing a geometric calculation based on the detected location and the known locations of the two or more markers.

12. The golf vehicle system of claim 1, wherein the detected location of the golf vehicle relative to the marker includes a distance and an orientation of the golf vehicle relative to the marker.

13. The golf vehicle system of claim 1, wherein the one or more processing circuits are configured to use the corrective position to (i) prevent the golf vehicle from leaving a cart path of the golf course or (ii) alter operation of the golf vehicle in response to the golf vehicle leaving the cart path.

14. The golf vehicle system of claim 1, wherein the one or more processing circuits include at least one of (i) a first processing circuit located on the golf vehicle or (ii) a second processing circuit located remote from the golf vehicle.

15. A vehicle system comprising:
one or more processing circuits including one or more memory devices coupled to one or more processors, the one or more memory devices configured to store instructions thereon that, when executed by the one or more processors, cause the one or more processors to:
acquire a tracked location of a vehicle;
acquire vision data including a marker in an environment surrounding the vehicle, the marker associated with a known location;
determine a detected location of the vehicle relative to the marker based on the vision data, the detected location including a distance and an orientation of the vehicle relative to the marker;
determine a corrective position of the vehicle relative to the tracked location based on the tracked location, the detected location, and the known location; and
control an operation of the vehicle based on the corrective position.

16. (canceled)

17. The vehicle system of claim 15, wherein the instructions cause the one or more processors to:
acquire a GPS position of the vehicle, wherein the tracked location is the GPS position;
permit unrestricted operation of the vehicle when the GPS position indicates that the vehicle is located in a restricted operation area, but the corrective position indicates that the vehicle is not in the restricted operation area; and
limit operation of the vehicle when the GPS position indicates that the vehicle is not located in a restricted operation area, but the corrective position indicates that the vehicle is in the restricted operation area.

18. The vehicle system of claim 15, wherein the marker is a first marker associated with a first known location, and wherein the instructions cause the one or more processors to:
acquire vision data of a ground surface including a second marker associated with a second known location, the second marker positioned along the ground surface such that as the vehicle drives over or proximate the second marker, the vision data including the second marker is acquired; and
responsive to driving over or proximate the second marker, determine that the corrective position of the vehicle is the second known location of the second marker.

19. The vehicle system of claim 15, wherein the instructions cause the one or more processors to determine, based on the vision data, the detected location of the vehicle relative to two or more markers included in the vision data, each marker of the two or more markers associated with known locations, and wherein determining the corrective position of the vehicle includes performing a geometric calculation based on the detected location and the known locations of the two or more markers.

20. A golf vehicle system comprising:
a non-transitory computer-readable medium having instructions stored thereon that, when executed by one or more processors, cause the one or more processors to:
acquire a tracked location of a golf vehicle;
acquire vision data including a first marker in an environment surrounding the golf vehicle, the first marker associated with a first known location;
determine a detected location of the golf vehicle relative to the first marker based on the vision data, the detected location including a distance and an orientation of the golf vehicle relative to the first marker;
acquire vision data of a ground surface including a second marker associated with a second known location, the second marker positioned along the ground surface such that as the golf vehicle drives over or proximate the second marker, the vision data including the second marker is acquired;
determine at least one of (i) a corrective position of the golf vehicle relative to the tracked location based on the tracked location, the detected location, and the first known location or (ii) responsive to driving over or proximate the second marker, that the corrective position of the golf vehicle is the second known location of the second marker; and
control an operation of the golf vehicle based on the corrective position of the golf vehicle.

21. The golf vehicle system of claim 1, wherein the tracked location is different from the detected location.
